(19) United States
(12) Patent Application Publication
(10) Pub. No.: US 2020/0325995 A1
(43) Pub. Date: Oct. 15, 2020

(54) Valve

(71) Applicant: Vitesco Technologies GmbH, Hannover (DE)

(72) Inventor: Rosario BONANNO, Schwalbac a. Ts. (DE)

(21) Appl. No.: 16/956,299

(22) PCT Filed: Dec. 19, 2018
(86) PCT No.: PCT/EP2018/085828

§ 371 Date: Jun. 19, 2020

(30) Foreign Application Priority Data
Dec. 21, 2017 (DE) 10 2017 223 583.7

(51) Int. Cl. F16K 1/46; F16K 1/36; F16K 31/06; F16J 15/10

(52) U.S. Cl. CPC F16K 1/46; F16K 1/36; F02B 37/16; F16J 15/106; F16K 31/0655

(57) ABSTRACT

A valve includes: a housing; a solenoid arranged in the housing; a pin movable by the solenoid; a cup-shaped piston connected to the pin; and a seal arranged in the housing and configured to seal the piston against the housing. The seal is a disk having a radially inner sealing surface clamped at a radially outer edge in the housing.

### CROSS REFERENCE TO RELATED APPLICATIONS

This is a U.S. national stage of International application No. PCT/EP2018/085828, filed on Dec. 19, 2018, which claims priority to German Application No. 10 2017 223 583.7, filed Dec. 21, 2017, the content of each of which is incorporated herein by reference.

### BACKGROUND OF THE INVENTION

### 1. Field of the Invention

The invention relates to a valve having a housing, a solenoid arranged in the housing, a pin movable by the solenoid, a cup-shaped piston, which is connected to the pin, and a seal, which is arranged in the housing and seals the piston against the housing.

### 2. Related Art

Such valves are used, inter alia, as a diverter valve on the turbocharger in motor vehicles to open up a bypass to the suction side in overrun operation, and are thus known. In order to prevent excessive deceleration of the turbocharger, but also to ensure a fast start-up, rapid opening and closing of the valve are essential prerequisites. In particular during the closing process, immediate closure as a result of the abutment of the piston against a valve seat is of importance. The valve seat is formed by the housing of the turbocharger, on which the valve is flange-mounted. Here, the axially displaceable piston is sealed against the housing. The sealing is realized via a seal. Such seals often have a V-shaped cross section, with the limbs of the V being formed as sealing lips. Seals with such V-shaped cross sections are also produced from plastic, wherein the method of production is dependent on the material. Depending on the material, such seals are produced by turning, which leads to high costs for the seal.

### SUMMARY OF THE INVENTION

An object of the invention is therefore to provide a valve that makes possible simple sealing of the piston against the housing. The valve should furthermore be inexpensive.

The object may be achieved in accordance with one aspect of the invention, by [symbol] a seal as a disk having a radially inner sealing surface, which is clamped at the radially outer edge in the housing. The cross section of such a seal is significantly simpler and thus less expensive than conventional seals. It has surprisingly been found that reliable sealing of the piston can be accomplished, despite the simple cross-sectional geometry, if the seal is clamped in place. Here, the disk shape offers a suitable geometry, and therefore clamping can likewise be performed with little effort.

In one advantageous embodiment, the clamping of the disk is particularly simple if the disk is clamped between the housing and a housing bushing. The advantage is that conventional valves have these two components. It is therefore possible to retrofit even already existing valves with the new seal. Only the housing and the housing bushing have to be modified slightly. The effort involved in adaptation is therefore limited.

According to another embodiment, the sealing effect can be increased if the disk rests under preload against the piston.

Depending on the type of preload, there is a certain friction between the seal and the piston during a movement. Sufficient preload with relatively low friction is achieved if the disk is conical. In this case, “conical” is interpreted to mean a disk geometry in the form of a Belleville spring. By virtue of this shape, the sealing surface engages at an angle on the cylindrical wall of the cup-shaped piston. It has been found that an angle of 30° to 50° is particularly advantageous.

The long-term stability of the seal can be further improved if the clamping imposes as small a load as possible on the seal. In an advantageous embodiment, the seal is clamped between the housing and another component, wherein the other component, preferably a cylinder bushing surrounding the piston, has a radially inwardly directed collar, on which the conical seal rests, wherein the collar is aligned at an angle to the cylindrical wall thereof. The angle preferably corresponds to the slope of the cone, with the result that the conical seal rests flat on the collar. When the seal is clamped with the housing, the force is distributed uniformly over the cross section.

In another advantageous embodiment, the friction can be further reduced here if the disk is composed of polytetrafluoroethylene (PTFE).

Such a disk can be produced easily as a turned part.

The lifetime wear can be achieved with a sealing effect which does not decline by virtue of the fact that the sealing surface of the disk has a radius.

In another embodiment, the clamping of the seal is simple if the disk is molded onto the housing or housing part. In this way, a particularly intimate bond is achieved between the seal and the clamping component. Another advantage is that installation of the seal is eliminated.

### BRIEF DESCRIPTION OF THE DRAWINGS

The invention will be described in more detail on the basis of an exemplary embodiment. In the drawings:

FIG. 1 is a sectional illustration of a valve according to the prior art; and

FIG. 2 is an enlarged sectional illustration of the valve according to the invention in the region of the piston.

### DETAILED DESCRIPTION OF THE PRESENTLY PREFERRED EMBODIMENTS

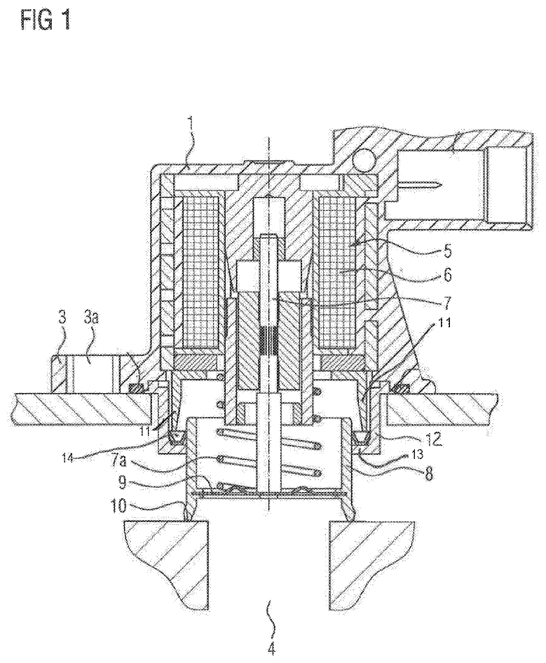

FIG. 1 shows the valve, which comprises a housing 1. The housing 1 furthermore has an integrally formed flange 3, via which the housing 1 is flanged-mounted on a turbocharger (not illustrated) in the region of a bypass line 4. In the housing 1, there is arranged a solenoid 5 with a coil 6 and a metal pin 7. The metal pin 7 is connected to a cup-shaped piston 8 which has a seal 10 at the periphery of its base 9. Here, a spring 7a pushes the piston 8 in the direction of the valve seat.

The housing 1 furthermore has a cylindrical section 11 which extends in the direction of the piston 8. A cylinder bushing 12 connected to the housing 1 surrounds the cylindrical section 11. The cylinder bushing 12 has a radially inwardly directed collar 13, on which a V-shaped seal 14 rests. The end of the cylindrical section 11 holds the seal 14 in position. The inner limb of the seal 14 seals the piston against the housing. If the solenoid 5 is electrically energized, a magnetic force acts on the armature 2, whereby the piston 8 is moved in the direction of the housing 1. Here, the seal 14 seals off the piston 8 against the housing 1.

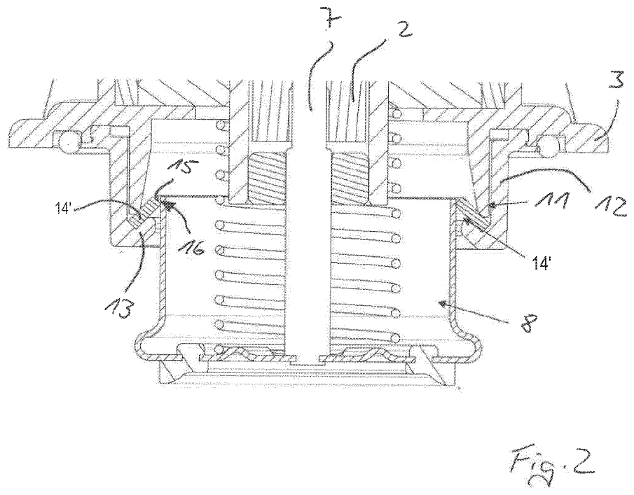

The valve according to the invention in FIG. 2 has a conical seal 14′ composed of PTFE with a thickness of 1 mm. The sealing surface 15, which rests against the piston 8, has a radius 16. By its underside, the seal 14′ rests flat on a radially inwardly projecting collar 13, which slopes in a manner corresponding to the conical shape. The seal 14′ is clamped by the cylindrical section 11 of the housing 1, which rests on the radially outer edge of the disk.

Although exemplary embodiments have been discussed in the above description, it should be noted that numerous modifications are possible. Furthermore, it should be noted that the exemplary embodiments are merely examples which are not intended to limit the scope of protection, the applications and the structure in any way. Rather, a person skilled in the art will take from the above description a guideline for implementation of at least one exemplary embodiment, wherein various modifications may be made, in particular with regard to the function and arrangement of the described components, without departing from the scope of protection as can be gathered from the claims and equivalent feature combinations.

1-8. (canceled)

9. A valve comprising:
a housing;
a solenoid arranged in the housing;
a pin movable by the solenoid;
a cup-shaped piston connected to the pin; and
a seal arranged in the housing and configured to seal the piston against the housing,
wherein the seal is a disk having a radially inner sealing surface clamped at a radially outer edge in the housing.

10. The valve as claimed in claim 9, wherein the disk is clamped between the housing and a cylinder bushing connected to the housing.

11. The valve as claimed in claim 10, wherein the disk contacts the piston under preload.

12. The valve as claimed in claim 9, wherein the disk is conical.

13. The valve as claimed in claim 9, wherein the disk is made of polytetrafluoroethylene (PTFE).

14. The valve as claimed in claim 13, wherein the disk is a turned part.

15. The valve as claimed in claim 13, wherein the sealing surface of the disk has a radius.

16. The valve as claimed in claim 10, wherein the disk is molded onto the housing or onto the cylinder bushing.
